(19) United States
(12) Patent Application Publication
(10) Pub. No.: US 2023/0046757 A1
(43) Pub. Date: Feb. 16, 2023

(54) Windows With Molded Layers of Polished Glass

(71) Applicant: Apple Inc., Cupertino, CA (US)

(72) Inventors: David E Kingman, San Francisco, CA (US); Albert J Golko, Saratoga, CA (US); Peter F Masschelein, Campbell, CA (US)

(21) Appl. No.: 17/845,824

(22) Filed: Jun. 21, 2022

Related U.S. Application Data
(60) Provisional application No. 63/232,569, filed on Aug. 12, 2021.

(51) Int. Cl. B60J 1/00; B32B 17/10; B32B 7/023

(52) U.S. Cl. CPC B60J 1/00; B32B 17/10036; B32B 17/10871; B32B 17/10467; B32B 7/023; B32B 2250/03; B32B 2250/40; B32B 2605/00; B32B 2419/00

(57) ABSTRACT

A vehicle or other system may have windows. The windows may be formed by laminating together molded sheets of polished float glass. Sheets of float glass may be polished on one side, leaving an opposing side unpolished. Following polishing, the sheets may be placed in a molding tool. The molding tool may mold the polished sheets into a desired shape such as a shape characterized by curved surfaces. The curved surfaces may include surfaces of compound curvature. Lamination equipment may use polymer to laminate first and second molded sheets of polished glass together with their polished sides facing outwardly away from each other. Light modulators and/or other electrically adjustable layers may be incorporated into the windows.

This application claims the benefit of provisional patent application No. 63/232,569, filed Aug. 12, 2021, which is hereby incorporated by reference herein in its entirety.

### FIELD

This relates generally to structures that pass light, and, more particularly, to windows.

### BACKGROUND

Windows are used in buildings and vehicles. Windows may be formed from glass or other transparent material.

### SUMMARY

A vehicle or other system may have windows. The windows may be formed by laminating together molded sheets of polished float glass. Light modulators and/or other electrically adjustable layers may be incorporated into the windows. For example, an electrically adjustable layer may be embedded in polymer between a pair of molded layers of polished glass.

Sheets of float glass may be polished on one side, leaving an opposing side unpolished. Following polishing, the polished sheets may be placed in a molding tool. The molding tool may mold the polished sheets into a desired shape such as a shape characterized by curved surfaces. The curved surfaces of the molded layers of polished glass may include surfaces of compound curvature. Lamination equipment may use polymer to laminate first and second molded layers of glass together with their polished sides facing away from each other.

### BRIEF DESCRIPTION OF THE DRAWINGS

FIG. 1 is a diagram of an illustrative system with windows in accordance with an embodiment.

FIG. 2 is a cross-sectional side view of an illustrative sheet of float glass during fabrication in accordance with an embodiment.

FIG. 3 is a cross-sectional side view of an illustrative sheet of float glass before polishing in accordance with an embodiment.

FIG. 4 is a cross-sectional side view of an illustrative sheet of polished float glass in accordance with an embodiment.

FIG. 5 is a top view of illustrative glass fabrication equipment in accordance with multiple layers in accordance with an embodiment.

FIG. 6 is a cross-sectional side view of an illustrative glass molding tool that may be used in molding polished glass layers in accordance with an embodiment.

FIG. 7 is a side view of an illustrative window with laminated sheets of molded polished float glass in accordance with an embodiment.

### DETAILED DESCRIPTION

A system may have one or more windows. The windows may have one or more layers of molded glass. The glass layers may be formed from sheets of polished float glass. The polished float glass may be molded to form desired window shapes.

The system in which the windows are used may be a building, a vehicle, or other suitable system. Illustrative configurations in which the system is a vehicle may sometimes be described herein as an example. This is merely illustrative. Window structures may be formed in any suitable systems.

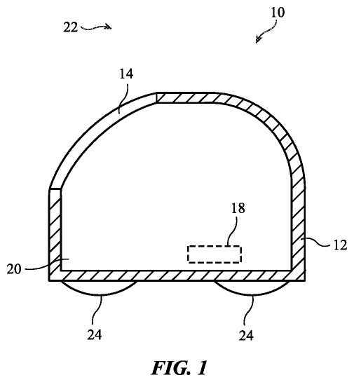

A cross-sectional side view of an illustrative system that includes windows is shown in FIG. 1. System 10 may be a vehicle, building, or other type of system. In an illustrative configuration, system 10 is a vehicle. As shown in the illustrative side view of system 10 in FIG. 1, system 10 may have support structures such as body 12. Body 12 may be a vehicle body that includes doors, trunk structures, a hood, side body panels, a roof, window pillars, and/or other body structures. Body 12 may be configured to surround and enclose an interior region such as interior region 20. System 10 may include a chassis to which wheels such as wheels 24 are mounted, may include propulsion and steering systems, and may include a vehicle automation system configured to support autonomous driving (e.g., a vehicle automation system with sensors and control circuitry configured to operate the propulsion and steering systems based on sensor data). This allows system 10 to be driven semi-autonomously and/or allows system 10 to be driven autonomously without a human operator.

One or more windows such as windows 14 may be mounted within openings in body 12. Windows 14 may, for example, be mounted on the front of body 12 (e.g., to form a front window on the front of a vehicle), on the rear of body 12 (e.g., to form a rear window at the rear of a vehicle), on the top (roof) of body 12 (e.g., to form a sun roof), and/or on sides of body 12 (e.g., to form side windows). Windows 14 may include windows that are fixed in place and/or may include windows that can be manually and/or automatically rolled up or down. For example, one or more windows 14 may be controlled using window positioners (e.g., window motors that open and close windows 14 in response to user input or other input). The area of each window 14 may be at least 0.1 m², at least 0.5 m², at least 1 m², at least 5 m², at least 10 m², less than 20 m², less than 10 m², less than 5 m², or less than 1.5 m² (as examples). Windows 14 and portions of body 12 may be used to separate interior region 20 from the exterior environment that is surrounding system 10 (exterior region 22).

System 10 may include components 18. Components 18 may include seats in the interior of body 12, sensors, control circuitry, input-output devices, and/or other vehicle components. Control circuitry in system 10 may include one or more processors (e.g., microprocessors, microcontrollers, application-specific integrated circuits, etc.) and storage (e.g., volatile and/or non-volatile memory). Input-output devices in system 10 may include displays, sensors, buttons, light-emitting diodes and other light-emitting devices, haptic devices, speakers, and/or other devices for providing output and/or gathering environmental measurements and/or user input. The sensors may include ambient light sensors, touch sensors, force sensors, proximity sensors, optical sensors, capacitive sensors, resistive sensors, ultrasonic sensors, microphones, three-dimensional and/or two-dimensional image sensors, radio-frequency sensors, and/or other sensors. Output devices may be used to provide a user with haptic output, audio output, visual output (e.g., displayed content, light, etc.), and/or other suitable output.

During operation, control circuitry in system 10 may gather information from sensors (e.g., environmental sensors) and/or other input-output devices, may gather user input such as voice commands provided to a microphone, may gather touch commands supplied to a touch sensor, may gather button input supplied to one or more buttons, etc. Control circuitry in system 10 may use this input in driving system 10 and in controlling windows and other parts of system 10.

Windows 14 may be formed from one or more glass layers. For example, two or more glass layers may be laminated together using polymer. The glass layers may be chemically or thermally tempered (e.g., to create compressive stress on the surfaces of the glass layers). The glass layers of windows 14 may sometimes referred to as structural glass layers due to the ability of such layers to provide structural support for windows 14. In some configurations, waveguide layers with light extraction features for providing in-window illumination, light modulating layers (e.g., layers exhibiting electrically adjustable amounts of light transmission), adjustable-haze layers, adjustable-reflectivity layers, and/or other electrically adjustable window layers may be incorporated into windows 14 (e.g., such layers may be laminated between outer and inner glass layers and/or other transparent window layers).

Windows 14 may have one or more planar portions and/or one or more curved portions. As an example, one or more portions of window 14 may be characterized by a curved cross-sectional profile and may have convex and/or concave exterior surfaces (and corresponding concave and/or convex interior surfaces). The curved portions of windows 14 may include curved surfaces that can be flattened into a plane without distortion, which are sometimes referred to as developable surfaces. The curved portions of window 14 may also include curved surfaces with compound curvature, which cannot be flattened into a plane without distortion and which are sometimes referred to as non-developable surfaces or doubly curved surfaces.

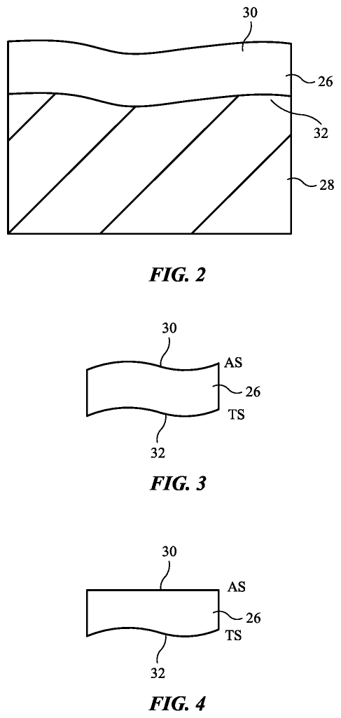

Glass sheets for windows 14 may be formed by polishing float glass and subsequently molding and laminating the polished float glass. FIG. 2 is a cross-sectional side view of an illustrative layer of float glass during fabrication. As shown in FIG. 2, in float glass manufacturing equipment, glass layer 26 floats on the surface of molten tin 28. This exposes upper glass surface 30 to air, so surfaces such as surface 30 of glass layer 26 may sometimes be referred to as air surfaces (AS). Opposing lower surface 32 of layer 26 is exposed to molten tin 28. Tin-exposed surfaces such as surface 32 may sometimes be referred to as tin surfaces (TS).

During fabrication, molten glass that is floating on layer 38 cools and forms a solid sheet of float glass, as shown by glass layer 26 of FIG. 3. In this state, layer 26 has one surface that was exposed to air during formation (air surface AS) and another surface that was exposed to tin during formation (TS). The air surface and tin surface of sheet are characterized by thickness variations (e.g., waviness due to variations in thickness of tens or hundreds of nm or other suitable amount). Waviness from these thickness variations, which may sometimes be referred to as float lines, can lead to undesired optical distortion.

To help reduce undesired optical distortion in glass layers 26 and windows 14, glass layer 26 may be polished to remove at least some of the float lines. As shown in FIG. 4, for example, glass layer 26 may be polished on one side (e.g., air side AS) while glass layer 26 is in a planar state (e.g., at the output of the float glass tool or at the input of a molding tool). The polishing process completely removes (or at least significantly reduces) thickness variations on the polished side of layer 26). Polishing is preferably performed before molding, while layer 26 can still be handled in large sheets (e.g., before layer 26 is cut into window-sized sections for molding) and before layer 26 has been molded to form curved surfaces that could pose polishing challenges.

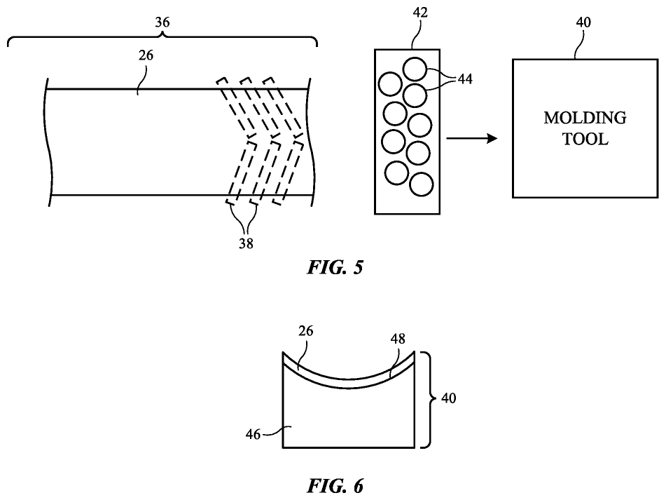

FIG. 5 is a top view of illustrative equipment for forming polished layers of glass for windows 14. Initially, in float glass manufacturing equipment 36, a layer of molten glass floats on a layer of molten tin. As glass layer 26 cools, layer 26 is fed to the output of equipment 36 by rollers 38. Molding tool 40 is used to mold glass layer 26 to a desired shape for use in a window. At the output of float glass manufacturing equipment 36 and/or at the input of molding tool 40, before glass layer 26 is molded, polishing equipment 42 is used to polish glass layer 26 (e.g., surface 30 of layer 26, as described in connection with FIG. 4).

Polishing equipment 42 may have an array of random orbital polishing pads 44 that polish the surface of glass layer 26. Polishing operations with pads 44 may be performed using cerium oxide polishing compound or other suitable polishing compound. Polishing may be performed until the planer polished surface of layer 26 exhibits a desired amount of flatness (e.g., a flatness associated with partial or complete float line removal, leading to visibly imperceptible float line distortion when layer 26 is assembled into a finished window). By polishing layer 26 while layer 26 is flat (e.g., before molding operation in tool 40), processing challenges that could make it difficult or impossible to polish layer 26 after molding can be avoided.

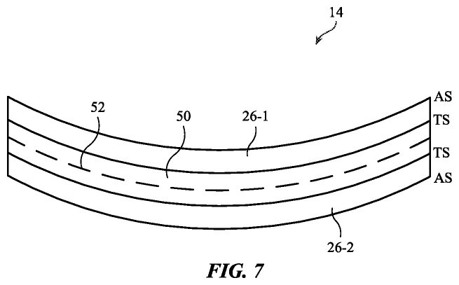

FIG. 6 is a cross-sectional side view of an illustrative molding tool for use in molding polished glass layers to form molded window layers. Initially, a sheet of polished glass is produced (e.g., a planar polished glass layer such as a layer of float glass of a desired thickness is produced by equipment 36 and polished by equipment 42). In an illustrative configuration, the air side (AS) of layer 26 is polished. The opposing tin side (TS) of layer 26 may have surface defects, which make the tin side more suitable for facing inward towards a polymer interlayer in a laminated window.

The polished glass sheet produced by equipment 36 and 42 is inserted into a molding tool such as molding tool 40 of FIG. 6. Molding tool 40 includes a heater for heating and thereby softening the glass of polished glass layer 26 (e.g., by heating the glass to a temperature of 700° C. or other suitable temperature). Tool 40 also includes one or more molds such as mold 46. Mold 46 in the example of FIG. 6 has a surface with compound curvature (concave surface 48). In general, mold 46 may have one or more compound curvature surfaces, developable surfaces, and/or planar surfaces. While glass layer 26 is soft due to heating, tool 40 molds glass layer 26 against surface 48. For example, tool 40 may apply a vacuum between glass layer 26 and mold 46 that draws layer 26 downwards against surface 48. If desired, the air side of layer 26 may face away from surface 48 (to help avoid creating mold surface defects) and the tin side of layer 26 may face towards surface 48 during molding.

Laminated windows have multiple glass layers 26 of the same shape and size. These glass layers are configured so that adjacent glass surfaces have matching curvature. To produce mating molded glass layers with inwardly facing tin surfaces having respective convex and concave surfaces, molding tools such as tool 40 of FIG. 6 may be provided with molds 46 having both concave and convex surfaces 48.

The use of a molding tool that has curved mold surfaces is illustrative. If desired, glass layers 26 may be molded using other types of molding equipment. As an example, molding tool 40 may be a ring tool that holds onto peripheral portions of layers 26 while layers 26 are molded into a desired shape by the force of gravity. Layers 26 may be provided with compound curvature using this type of molding arrangement, using pressure applied by heated mold dies, using a glass slumping mold, and/or using other suitable equipment for deforming glass into desired shapes while softened by applied heat. In general, any suitable type of molding tool may be used in forming layers 26 into desired shapes prior to lamination.

The layers of window 14 are attached to each other using lamination equipment (e.g., vacuum lamination equipment). A cross-sectional side view of an illustrative window 14 that has been formed by laminating together two molded polished glass sheets is shown in FIG. 7. As shown in the example of FIG. 7, window 14 may have a first glass layer such as layer 26-1 (e.g., an inner structural glass layer) and a second glass layer such as layer 26-2 (e.g., an outer structural glass layer). Additional layers of glass may be included in window 14 if desired. The use of a two-layer window design formed from a pair of molded layers of polished glass is presented as an example.

A layer of polymer such as polymer layer 50 may be used to attach layers 26-1 and 26-2 together. The polymer that is used between adjacent glass layers may be polyvinyl butyral or other suitable polymer and may have a thickness of at least 0.3 mm, at least 0.6 mm, less than 0.9 mm, less than 1.1 mm, and/or other suitable thickness. The refractive index of layer 50 may be matched to that of layers 26-1 and 26-2 to help reduce light reflections.

Tin surfaces TS of layers 26-1 and 26-2 may face inwardly towards layer 50, whereas opposing air surfaces AS of layers 26-1 and 26-2 may face outwardly. This type of arrangement may help improve window performance for window 14, because the unpolished tin sides of layers 26-1 and 26-2 are more likely to have surface defects and float lines that could create visible artifacts. When the float lines and other surface features face inwardly towards layer 50, the index matching properties of layer 50 help prevent reflections from these features of tin sides TS and thereby visually hide these features. The polished air sides AS of layers 26-1 and 26-2 face outwardly towards the air, so that the absence of float lines and/or other features on these polished surfaces may help avoid any adverse impact on optical performance.

If desired, electrically adjustable layers (e.g., one or more electrically adjustable layers in layer(s) 52) may be incorporated into window 14 (e.g., by laminating one or more such layers between respective glass layers to embed layer(s) 52 in polymer 50 as shown in FIG. 7). Layers such as layer 52 may include adjustable light transmission layers such as guest-host liquid crystal layers (sometimes referred to as light modulator layers), layers that exhibit adjustable amounts of haze (e.g., layers based on polymer-dispersed liquid crystal structures), layers that exhibit adjustable amounts of color cast (e.g., guest-host layers), layers such as cholesteric liquid crystal layers that exhibit adjustable amounts of reflectivity, layers that exhibit adjustable amounts of polarization, and/or other electrically adjustable layer(s).

The foregoing is merely illustrative and various modifications can be made to the described embodiments. The foregoing embodiments may be implemented individually or in any combination.

What is claimed is:

1. A vehicle, comprising:
a vehicle body; and
a window in the vehicle body, wherein the vehicle body and the window separate an interior vehicle region from an exterior region and wherein the window has first and second molded layers of polished glass.

2. The vehicle defined in claim 1 wherein the first molded layer of polished glass has a polished air surface and an unpolished tin-exposed surface, wherein the second molded layer of polished glass has a polished air surface and an unpolished tin-exposed surface, and wherein the window further comprises a layer of polymer that attaches the tin-exposed surfaces of the first and second molded layers of polished glass together.

3. The vehicle defined in claim 2 wherein the first and second molded layers have surfaces with compound curvature.

4. The vehicle defined in claim 1 wherein the window comprises a polymer layer coupled between the first and second molded layers of polished glass.

5. The vehicle defined in claim 4 wherein the window further comprises an electrically adjustable layer in the polymer layer.

6. The vehicle defined in claim 1 wherein the first molded layer of polished glass has a polished surface and an unpolished surface.

7. The vehicle defined in claim 6 wherein the window further comprises a layer of polymer between the first and second molded layers of polished glass and wherein the layer of polymer is attached to the unpolished surface.

8. The vehicle defined in claim 7 wherein the first and second molded layers of polished glass are formed from polished sheets of float glass.

9. The vehicle defined in claim 8 wherein the window has an area of compound curvature.

10. The vehicle defined in claim 1 further comprising an electrically adjustable layer between the first and second molded layers of polished glass.

11. A window, comprising:
a first molded layer of polished glass having a surface with curvature, wherein the first molded layer of polished glass is formed by molding a first sheet of planar polished float glass; and
a second molded layer of polished glass having a surface with curvature, wherein the second molded layer of polished glass is formed by molding a second sheet of planar polished float glass.

12. The window defined in claim 11 further comprising polymer between the first and second molded layers.

13. The window defined in claim 12 wherein the first and second molded layers each have a polished surface and an unpolished surface.

14. The window defined in claim 12 wherein the polished surfaces face outwardly from the polymer and wherein the unpolished surfaces are contacted by the polymer.

15. The window defined in claim 14 wherein the surfaces of the first and second molded layers have compound curvature.

16. The window defined in claim 11 further comprising an electrically adjustable layer.

17. A vehicle window configured to separate a vehicle interior region from an exterior region, the vehicle window comprising:
an outer molded layer of polished float glass with compound curvature; and
an inner molded layer of polished float glass with compound curvature.

18. The vehicle window defined in claim 17 further comprising polymer between the outer and inner molded layers of polished float glass.

19. The vehicle window defined in claim 18 wherein the outer molded layer has a polished surface and an unpolished surface, wherein the inner molded layer has a polished surface and an unpolished surface, and wherein the unpolished surfaces face towards each other and contact the polymer.

20. The vehicle window defined in claim 17 further comprising an electrically adjustable light modulator layer between the outer molded layer and the inner molded layer.
